(19) United States
(12) Patent Application Publication
(10) Pub. No.: US 2022/0302754 A1
(43) Pub. Date: Sep. 22, 2022

(54) CONTROL APPARATUS FOR CONTROLLING MOTOR OPERATION AND CHARGING APPARATUS

(71) Applicant: Panasonic Intellectual Property Management Co., Ltd., Osaka (JP)

(72) Inventors: Takaharu Shigeta, Kanagawa (JP); Kunihiro Moro, Kanagawa (JP)

(21) Appl. No.: 17/697,768

(22) Filed: Mar. 17, 2022

(30) Foreign Application Priority Data
Mar. 17, 2021 (JP) 2021-043139
Nov. 5, 2021 (JP) 2021-180887

(51) Int. Cl. H02J 50/00; H02J 50/90; H02J 50/12; H02P 8/34

(52) U.S. Cl. CPC H02J 50/005; H02J 50/90; H02J 50/12; H02P 8/34; H02J 7/0044

(57) ABSTRACT

A control apparatus controls the operation of a stepping motor. The output unit operates a motor in a stopped state at a first driving frequency and switches to a second driving frequency at a stable point. The first driving frequency is a frequency lower than a resonance frequency range of the motor, and the second driving frequency is a frequency higher than the resonance frequency range of the motor.

### BACKGROUND

### 1. Field

The present invention relates to control technology and, more particularly, to a control apparatus for controlling the operation of a motor and a charging apparatus.

### 2. Description of the Related Art

When a stepping motor is accelerated or decelerated, vibration is produced in the stepping motor if a driving frequency in a resonance frequency domain inherent in the stepping is used to drive the stepping motor. A method is presented for accelerating, maintaining a constant speed of, and decelerating a stepping motor in such a manner as to avoid the resonance frequency domain of the stepping motor itself in order to reduce the vibration produced in the stepping motor (see, for example, patent literature 1).
[Patent Literature 1] JPH10-98898

A stepping motor is used, for example, to move a coil in a charging apparatus mounted on a vehicle and capable of performing wireless charging. Therefore, a stepping motor may be used in an ambient temperature of −20° C. At a low temperature, the viscosity of grease is increased so that the torque necessary to drive the stepping motor is increased. When a stepping motor is driven in such a manner as to avoid a driving frequency in the resonance frequency domain, however, the likelihood is increased that the stepping motor cannot be driven properly, the torque will be insufficient, and synchronization will be lost.

### SUMMARY

The present disclosure addresses the aforementioned issue, and a purpose thereof is to provide a technology of preventing loss of synchronization of the motor from occurring and, at the same time, reducing noise in a situation in which the ambient temperature changes.

A control apparatus according to an embodiment of the present disclosure includes a controller that operates a motor in a stopped state at a first driving frequency and switches from the first driving frequency to a second driving frequency at a stable point of the motor.

Another embodiment of the present disclosure also relates to a control apparatus. The apparatus includes a controller that, given that a first point of time for starting a motor operation and a second point of time later than the first point of time are defined, operates the motor in a stopped state at a first driving frequency since the first point of time and switches from the first driving frequency to a second driving frequency at the second point of time, the second point of time being a stable point of the motor.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a perspective view showing the interior of a vehicle according to an embodiment;

FIG. 2 is a perspective view showing a structure of the charging apparatus of FIG. 1;

FIG. 3 is a perspective view showing an electronic appliance placed on the charging apparatus of FIG. 2;

FIG. 4 is a perspective view showing the charging apparatus of FIG. 2 with a part thereof being removed;

FIG. 5 is a top view showing a structure of the charging apparatus of FIG. 4;

FIG. 6 is a cross-sectional view showing a structure of the charging apparatus of FIG. 2;

FIG. 7 is a cross-sectional view showing a structure of the support plate of the charging apparatus of FIG. 2;

FIG. 8 is a plan view showing a structure of the support plate of the charging apparatus of FIG. 2;

FIG. 9 shows a structure of the charging apparatus of FIG. 2;

FIG. 10 shows driving waveforms in the XA phase coil and the XB phase coil of FIG. 9;

FIGS. 11A-11C show the characteristics of a stepping motor;

FIG. 12 shows a relationship between the driving frequency and the noise level;

FIGS. 13A-13D show an outline of the operation of the motor;

FIG. 14 shows an outline of an alternative operation of the motor;

FIGS. 15A-15B show an outline of the operation of the motor according to a variation; and

FIGS. 16A-16B are flowcharts showing sequences of steps to control the motor according to the variation.

### DETAILED DESCRIPTION

The invention will now be described by reference to the preferred embodiments. This does not intend to limit the scope of the present invention, but to exemplify the invention.

A brief summary will be given before describing the present disclosure in specific details. An embodiment of the present disclosure relates to a charging apparatus capable of performing non-contact charging, i.e., wireless charging. The charging apparatus wirelessly charges an electronic appliance placed on the upper surface of the charging apparatus. An example of the electronic appliance is a mobile terminal apparatus such as a smartphone. One of the international standards for wireless charging is Qi formulated by Wireless Power Consortium (WPC). In wireless charging like Qi, an appliance is charged efficiently by causing the charging coil of the charging apparatus and the coil of the electronic appliance to face each other. Thus, the charging apparatus according to the embodiment moves the charging coil to face the coil of the electronic appliance. Movement of the charging coil is made by transforming the rotation of a stepping motor by microstepping into linear movement.

In microstepping, a table listing values derived from dividing a pseudo sine wave into 64 steps is prepared in advance, and the values in the table are output sequentially according to pulse width modulation (PWM) or digital-to-analog (DA). The stepping motor is operated in accordance with an output as described above. To start charging early, the stepping motor is operated to move the charging coil in a stopped state and increase the speed since then. For this purpose, it is therefore necessary to change the rotation speed of the stepping motor. If the frequency from the rotation of the stepping motor matches a resonance frequency inherent in the motor itself, it will produce a vibration and produce a noise in the apparatus.

In order to suppress the noise, the stepping motor is driven according to the related art in such a manner as to avoid the driving frequency in the resonance frequency domain. In the case a stepping motor is used in a vehicle, it is required to drive the stepping motor under a low-temperature environment, as described above. At a low temperature, the viscosity of grease is increased so that the torque necessary to drive the stepping motor is larger than at an ordinary temperature. When a stepping motor is driven in such a manner as to avoid the driving frequency in the resonance frequency domain, however, the likelihood is increased that the stepping motor cannot be driven properly, the torque will be insufficient, and synchronization will be lost.

In this embodiment, a driving frequency lower than the resonance frequency domain (hereinafter, “first driving frequency”) is used to initiate a start-up operation in the start/stop region of the motor at a driving frequency that produces a large torque to leave a zone of static friction from a drive load, which is largest in the still state. After the stepping motor is started to be rotated, and, at a point of time when a stable point of the stepping motor arrives, the first driving frequency is switched to a driving frequency higher than the resonance frequency domain (hereinafter, “second driving frequency”) to make a transition to a constant-speed driving (maximum speed). The terms “parallel” and “orthogonal” in the following description not only encompass completely parallel or orthogonal but also encompass slightly off-parallel and slightly non-orthogonal within the margin of error. The term “substantially” means identical within certain limits.

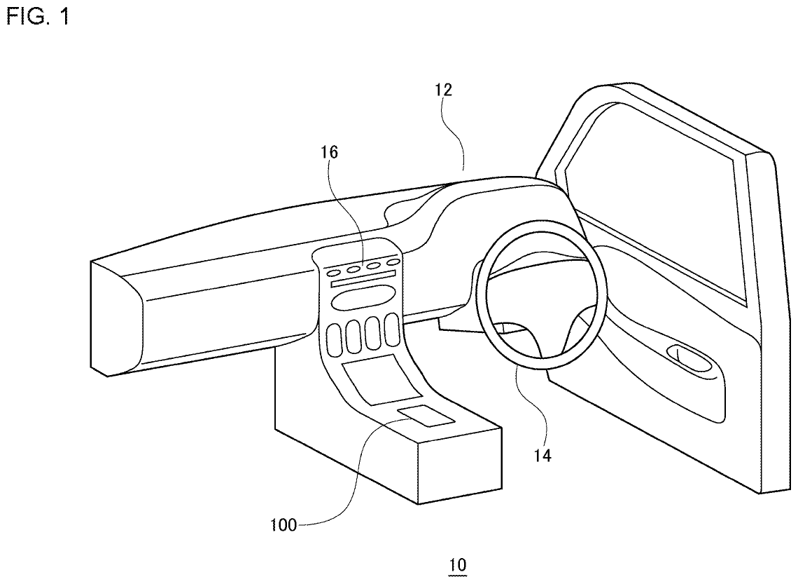

FIG. 1 is a perspective view showing a vehicle interior 12 of a vehicle 10. A steering wheel 14 is provided on the right side toward the front of the vehicle interior 12 of the vehicle 10. The steering wheel 14 may be provided on the left side. Also, a center console 16 is provided to the side of the steering wheel 14, i.e., at the center toward the front of the vehicle interior 12 of the vehicle 10. Further, a charging apparatus 100 is provided behind the center console 16 in the vehicle interior 12.

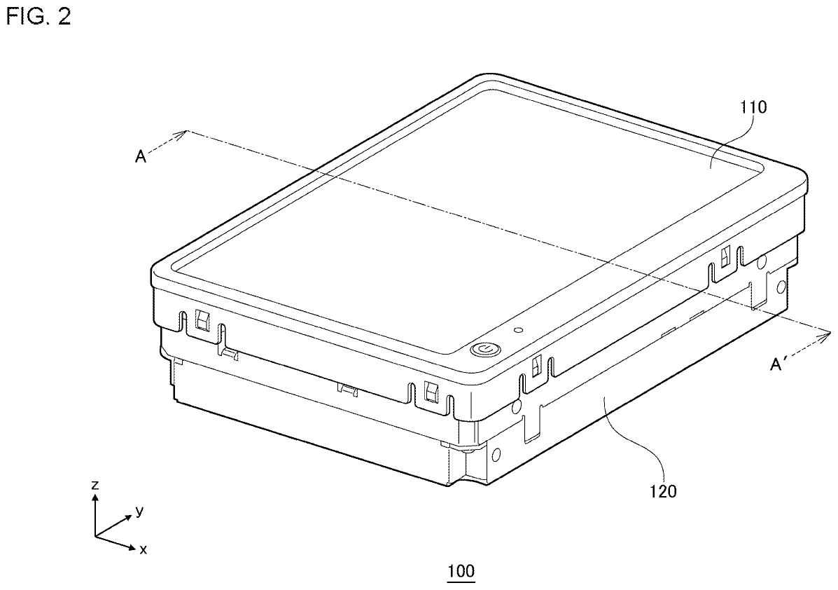

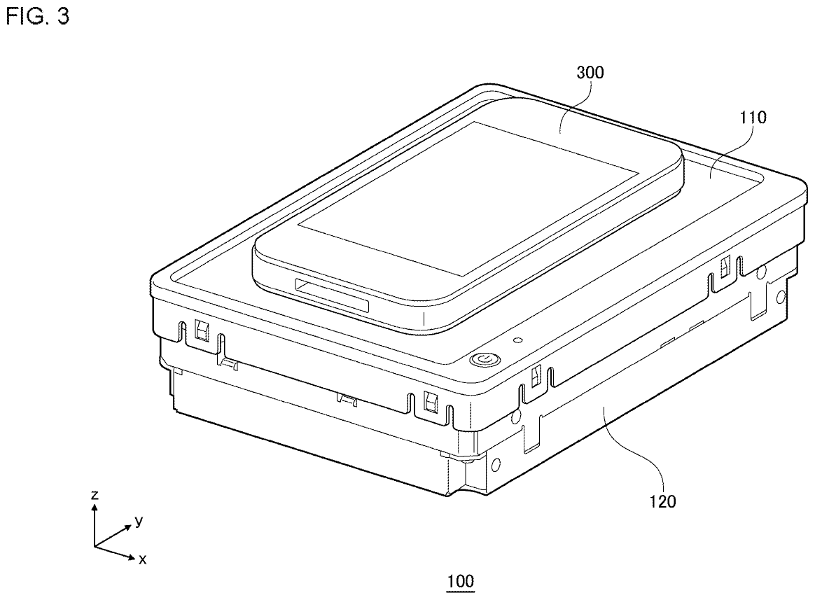

FIG. 2 is a perspective view showing a structure of the charging apparatus 100. FIG. 3 is a perspective view showing an electronic appliance 300 placed on the charging apparatus 100. As shown in FIGS. 2, 3, an orthogonal coordinate system including an x axis, y axis, and a z axis is defined. The x axis and y axis are orthogonal to each other. The z axis is perpendicular to the x axis and y axis and extends in the direction of thickness of the charging apparatus 100. The positive directions of the x axis, y axis, and z axis are defined in the directions of arrows in FIGS. 2, 3, and the negative directions are defined in the directions opposite to those of the arrows. In the following description, the positive direction of the z axis may be referred to as “above”, “upper side”, “upper surface side”, and the negative direction of the z axis may be referred to as “below”, “lower side”, “lower surface side”.

The charging apparatus 100 includes a support plate 110 and a body case 120. The combination of the support plate 110 and the body case 120 has a box shape. The support plate 110 is provided on top of the body case 120. The electronic appliance 300 is an apparatus charged by the charging apparatus 100 and is, as described above, exemplified by a mobile terminal apparatus such as a smartphone. When the electronic appliance 300 is placed on the support plate 110, the charging apparatus 100 charges the electronic appliance 300.

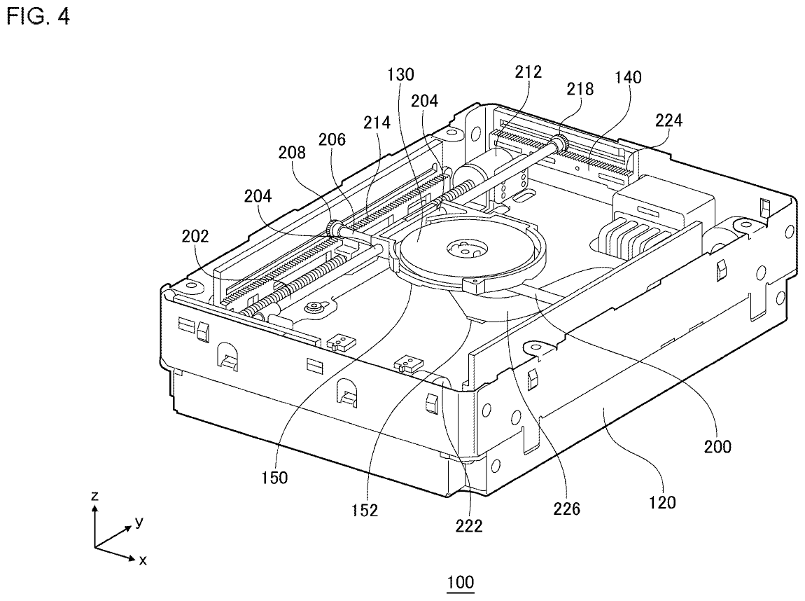

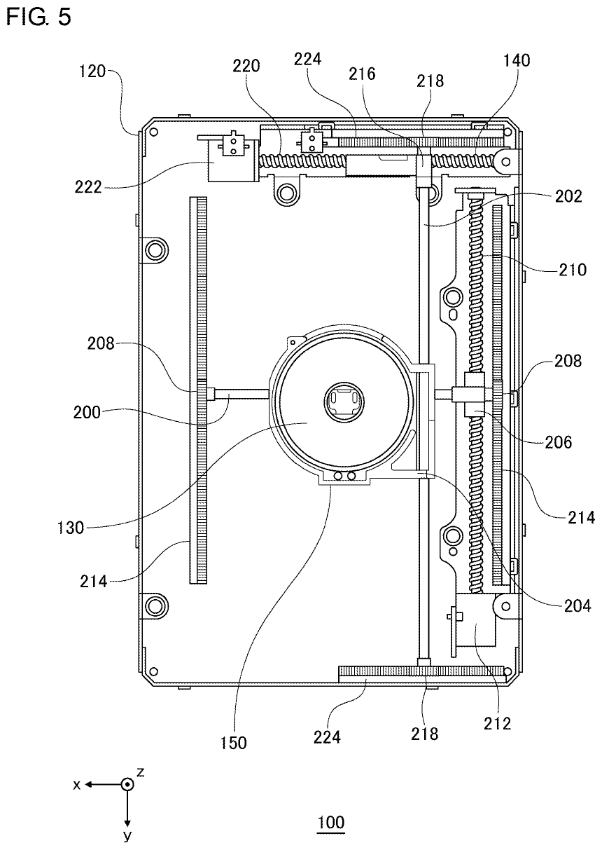

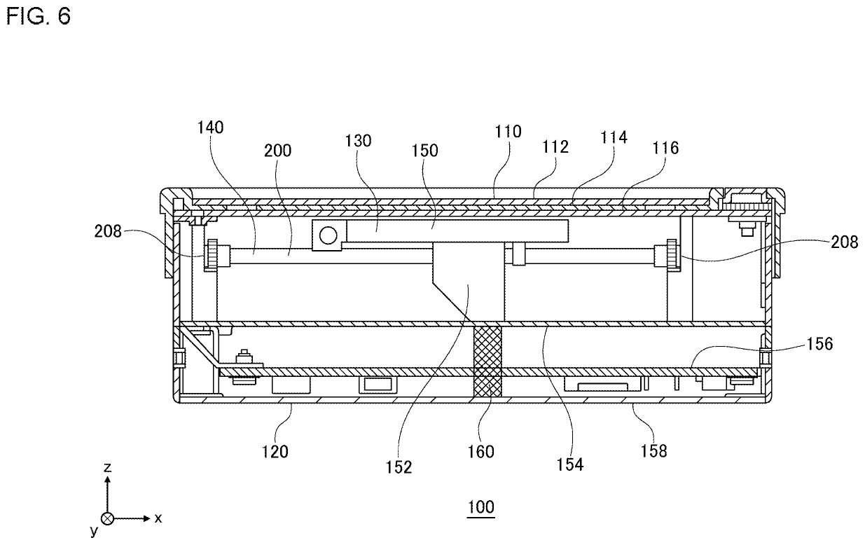

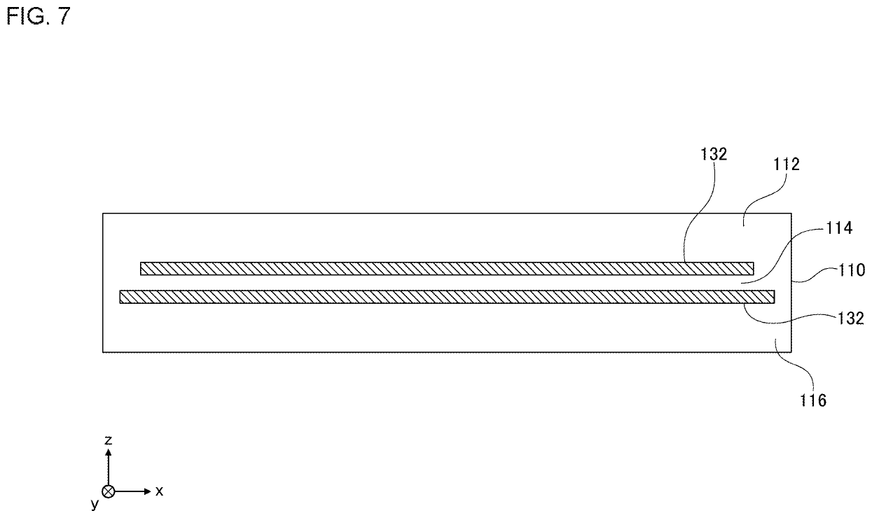

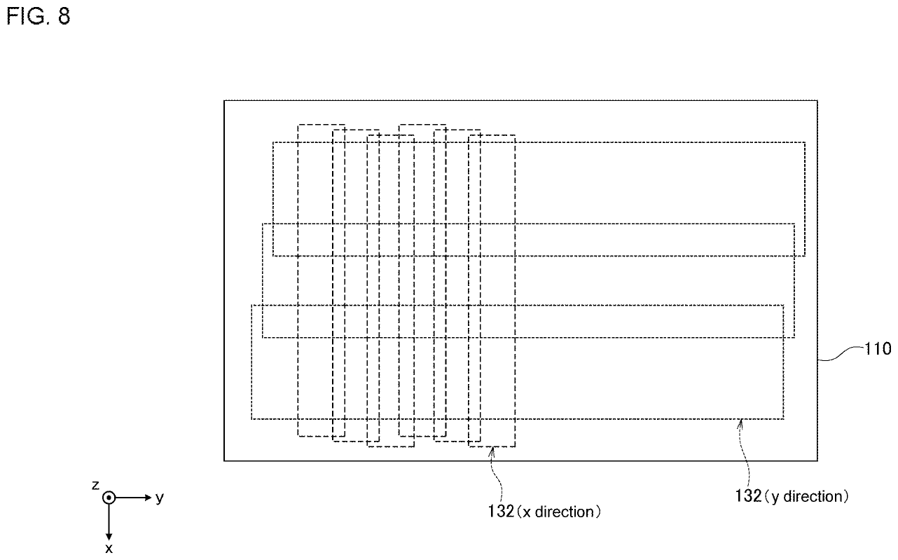

FIG. 4 is a perspective view showing the charging apparatus 100 with a part thereof being removed. FIG. 4 shows a view revealed when the support plate 110 is removed from the charging apparatus 100 of FIG. 2. FIG. 5 is a top view showing a structure of the charging apparatus 100 of FIG. 4. FIG. 6 is a cross-sectional view along A-A′ of FIG. 2 showing a structure of the charging apparatus 100. FIG. 7 is a cross-sectional view showing a structure of the support plate 110 of the charging apparatus 100. FIG. 8 is a plan view showing a structure of the support plate 110 of the charging apparatus 100. In the body case 120, the charging coil 130 is provided to be movable in the horizontal direction such that it remains facing the under surface of the support plate 110 of FIG. 2. A driver 140 for moving the charging coil 130 in the horizontal direction, maintaining the condition of facing the under surface of the support plate 110, and a control apparatus (not shown) connected to the driver 140 and the charging coil 130 are also provided in the body case 120.

As shown in FIG. 6, a front surface plate 1112, a middle plate 114, and a rear surface plate 116 are stacked in the support plate 110 in the vertical direction. The front surface plate 112 and the rear surface plate 116 are made of a synthetic resin, and the middle plate 114 is made of a ceramic. This allows the magnetic flux from the charging coil 130 described later to pass through the support plate 110 toward the electronic appliance 300. As shown in FIGS. 7 and 8, a plurality of detection coils 132 are provided on the front and rear surfaces of the middle plate 114 so as to be distributed on the x-y plane of the middle plate 114. For example, a plurality of detection coils 132 extending in the x-axis direction and a plurality of detection coils 132 extending in the y-axis direction are arranged to overlap each other in a matrix. Such an arrangement of the plurality of detection coils 132 is by way of example only, and the plurality of detection coils 132 may be arranged in a matrix so as not to overlap each other. The detection coil 132 detects whether the electronic appliance 300 is placed on the support plate 110 and detects at which position on the support plate 110 the electronic appliance 300 is placed. Based on the detection result, the driver 140 moves the charging coil 130 to a position that faces the coil of the electronic appliance 300.

As shown in FIGS. 4, FIG. 5, the charging coil 130 has an annular shape formed by a spirally wound wire member. The charging coil 130 is supported by a retaining member 150 of a synthetic resin on the outer circumferential side and the underside. A support leg 152 made of a synthetic resin and extending downward toward the lower side of the charging coil 130 is formed, as shown in FIG. 6, on the under surface of the retaining member 150 so as to be integrated with the retaining member 150. A gap of 0.3 mm is provided between the under surface of the support leg 152 and the upper surface of a metallic support plate 154 provided below the support leg 152. The gap prevents the under surface of the support leg 152 from coming into contact with the upper surface of the support plate 154 when the charging coil 130 is moved. A control board 156 and an under surface plate 158 of the body case 120 are provided below the support plate 154. For example, the aforementioned control apparatus is provided on the control board 156. A support member 160 extending through the control board 156 is provided between the under surface of the support plate 154 and upper surface of the under surface plate 158. In other words, the under surface side of the support plate 154 is supported by the under surface plate 158 of the body case 120 via the support member 160 so as to increase the strength against excess weight.

As shown in FIGS. 4, FIG. 5, the driver 140 has an Y-axis direction driving shaft 200 and an X-axis direction driving shaft 202. The middle part of each of the Y-axis direction driving shaft 200 and the X-axis direction driving shaft 202 is in contact with the part of the retaining member 150 other than the part that retains the charging coil 130. Therefore, a through hole (not shown) that the Y-axis direction driving shaft 200 extends through and a through hole 204 that the X-axis direction driving shaft 202 extends through are provided in the retaining member 150 at a predetermined vertical spacing so as to intersect each other. The Y-axis direction driving shaft 200 and the X-axis direction driving shaft 202 are in contact with the through holes.

A worm wheel 206 is provided at one end of the Y-axis direction driving shaft 200, and a gear 208 is provided in the worm wheel 206. A gear 208 is also provided at the other end of the Y-axis direction driving shaft 200 not provided with the worm wheel 206. The worm wheel 206 is engaged with a worm 210, and the worm 210 is coupled to a Y-axis motor 212. The gears 208 on both sides are engaged with gear plates 214, respectively. According to this structure, the worm 210 is rotated as the Y-axis motor 212 is driven, which moves the worm wheel 206 in the Y-axis direction along with the Y-axis direction driving shaft 200. Further, the charging coil 130 integrated with the Y-axis direction driving shaft 200 is moved in the y-axis direction. The mechanical part driven by the motor will be referred to as drive load hereinafter.

A worm wheel 216 is provided at one end of the X-axis direction driving shaft 202, and a gear 218 is provided in the worm wheel 216. A gear 218 is also provided at the other end of the X-axis direction driving shaft 202 not provided with the worm wheel 216. The worm wheel 216 is engaged with a worm 220, and the worm 220 is coupled to an X-axis motor 222. The gears 218 on both sides are engaged with gear plates 224, respectively. According to this structure, the worm 220 is rotated as the X-axis motor 222 is driven, which moves the worm wheel 216 to move in the x-axis direction along with the X-axis direction driving shaft 202. Further, the charging coil 130 integrated with the X-axis direction driving shaft 202 is moved in the x-axis direction. A flexible wiring 226 shown in FIG. 4 energizes the charging coil 130. The end of the flexible wiring 226 is fixed to the side surface of the support leg 152.

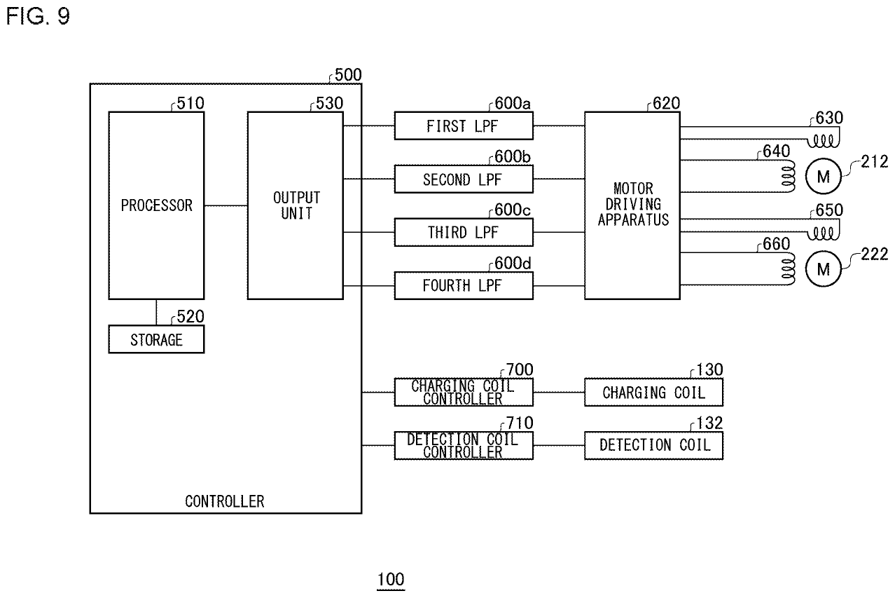

FIG. 9 shows a structure of the charging apparatus 100. The charging apparatus 100 includes the charging coil 130, the detection coil 132, the Y-axis motor 212, the X-axis motor 222, a control apparatus 500, a first LPF 600a, a second LPF 600b, a third LPF 600c, a fourth LPF 600d, which are generically referred to as LPF (Low-Pass Filter), a motor driving apparatus 620, a YA phase coil 630, a YB phase coil 640, an XA phase coil 650, an XB phase coil 660, a charging coil controller 700, a detection coil controller 710. The control apparatus 500 includes a processor 510, a storage 520, and an output unit 530.

As described above, a plurality of detection coils 132 are provided, but the figure shows them collectively. The detection coil controller 710 is connected to the detection coil 132. By controlling the operation of the detection coil 132, the detection coil controller 710 identifies the position where the coil of the control apparatus 50 is provided on the support plate 110. The detection coil controller 710 outputs the information related to the identified position (hereinafter, “position information”) to the control apparatus 500. The position information is represented by a coordinate in the x axis and a coordinate in the y axis.

The stepping motor is comprised of an iron stator and a magnetized rotor. When a current is induced in the coil, the stator is turned into an electromagnet. The magnetized rotor and the stator turned into an electromagnet attracts each other so that the rotor is stabilized and comes to a stopped state. By switching the excited part of the stator, a rotating magnetic field is produced, and the rotor is rotated. In a general structure of a claw pole PM (Permanent Magnet) stepping motor, a permanent magnet of a structure magnetized to produce an alternate arrangement of N poles and S poles is built in the rotor. The stator has a claw-shaped metallic part. When a current is induced in the winding wire coil, the claw part is magnetized into an S pole or an N pole. A rotary torque is produced by using attraction or repulsion between the magnetic pole of the stator, magnetized by the current in the winding wire, and the magnetic pole of the rotor. A description will be given below of a stepping motor of a step angle of 18 deg by way of one example. In this case, a total of 20 stable points 820 are available per one rotation of the motor. Naturally, a similar thinking can also be applied to cases in which the step angle differs.

The control apparatus 500 receives position information from the detection coil controller 710. The control apparatus 500 moves the charging coil 130 by rotating the Y-axis motor 212 and the X-axis motor 222 so that the charging coil 130 is located at the position indicated by the position information. In particular, the control apparatus 500 moves the charging coil 130 in the x-axis direction by rotating the X-axis motor 22 and moves the charging coil 130 in the y-axis direction by rotating the Y-axis motor 212. In other words, the Y-axis motor 212 or the X-axis motor 222 moves the position of the charging coil 130, and the control apparatus 500 controls the driving of the Y-axis motor 212 or the X-axis motor 222. The X-axis motor 222, the Y-axis motor 212 are generically referred to as “motor”. After moving the charging coil 130, the control apparatus 500 instructs the charging coil controller 700 to start charging. The charging coil controller 700 charges the electronic appliance 300 by controlling the operation of the charging coil 130 in response an instruction from the control apparatus 500.

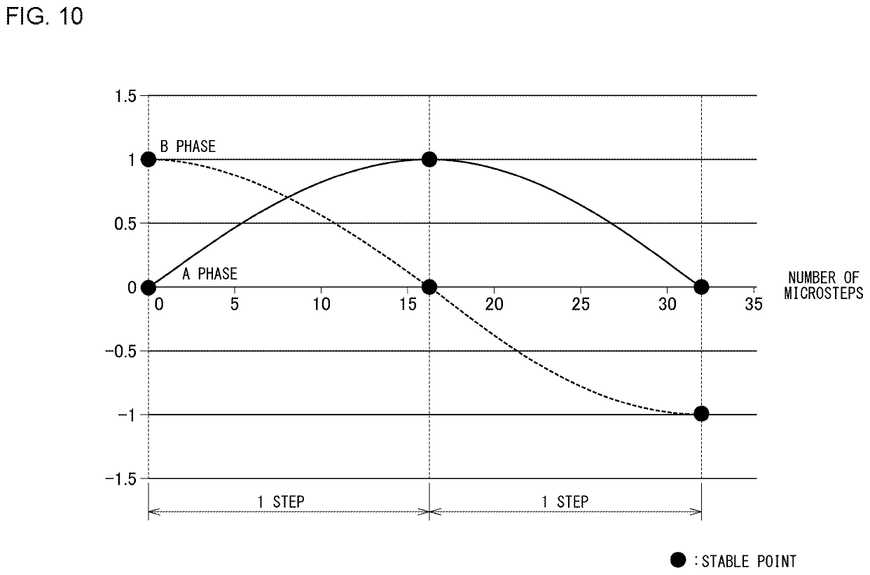

For rotation of the Y-axis motor 212 and the X-axis motor 222, microstepping is performed as described above. FIG. 10 will be used to explain an outline of microstepping. FIG. 10 shows driving waveforms in the XA phase coil 650 and the XB phase coil 660. The driving waveform in the XA phase coil 650 is shown as A phase, and the driving waveform in the XB phase coil 660 is shown as B phase. As illustrated, the driving waveform in A phase and the driving waveform in B phase are displaced in phase by 90 deg. For this reason, microstepping rotates the X-axis motor 222 by outputting driving waveforms displaced in phase by 90 deg to the XA phase coil 650 and the XB phase coil 660. As discussed in the above description of the motor structure, the largest attraction is produced at the maximum value and the minimum value in the respective phases, and the motor reaches the stable point at the values. Focusing on one current waveform (e.g., A phase), the extreme value (maximum value/minimum value) or the zero value of the sine wave represents the stable point of the motor.

Changing the driving waveform in A phase and the driving waveform in B phase by ¼ period (90 deg) rotates the X-axis motor 222 by one step, i.e., rotates the motor shaft by 18 deg. The point reached by 18 deg-rotation of the motor shaft from a stable point of the motor is also a stable point of the motor. When a period of the pseudo sine wave is divided into 64 stairsteps as described above, one stairstep represents a motor rotation angle of 1.125 deg. When the rotation angle of the motor is on the same stairstep, of the stairsteps derived from dividing the pseudo sine wave, as the stable point of the motor, an displacement from the rotation angle of the motor can be viewed as an error. The sine wave need not necessarily be divided into 64, but the number of division can be set as appropriate. Moreover, the rotation of the X-axis motor 222 by one step, i.e., a 18 deg-rotation of the motor shaft, moves the charging coil 130 by 0.1 mm, for example. Reducing the period of one step causes the X-axis motor 222 to be rotated faster and reduces a period elapsed until the charging coil 130 is moved by 0.1 mm. This is equivalent to increasing the speed of movement of the charging coil 130. Meanwhile, extending the period of one step causes the X-axis motor 222 to be rotated slower and extends a period elapsed until the charging coil 130 is moved by 0.1 mm. This is equivalent to moving the charging coil 130 faster. The discussion also applies to the YA phase coil 630, the YB phase coil 640, and the Y-axis motor 212 so that a description thereof is omitted. Reference is made back to FIG. 9.

To implement microstepping as described above, a table derived from dividing one period of a pseudo sine wave into a plurality of (e.g. 64) steps is stored in the storage 520. The processor 510 reads a value in the table at a time interval commensurate with the driving frequency to produce a driving waveform having a pseudo sine wave shape. The driving waveform has, for example, a stairstep shape. The driving waveform produced in the processor 510 and, for example, the driving waveform in A phase in the x-axis direction is output from the output unit 530 the third LPF 600c. The third LPF 600c approximates the shape of the driving waveform to a sine wave by smoothing the driving waveform having a stairstep shape. The third LPF 600c outputs the driving waveform to the motor driving apparatus 620. The motor driving apparatus 620 produces a driving current based on the driving waveform received and induces the driving current in the XA phase coil 650.

With regard to B phase in the x-axis direction, the driving waveform discussed so far is merely displaced by 90 deg. The processor 510, the output unit 530, the fourth LPF 600d, the motor driving apparatus 620, and the XB phase coil 660 operate as already described above. With regard to the Y-axis direction, too, the processor 510, the output unit 530, the first LPF 600a, the second LPF 600b, the motor driving apparatus 620, the YA phase coil 630, and the YB phase coil 640 operate as already described above.

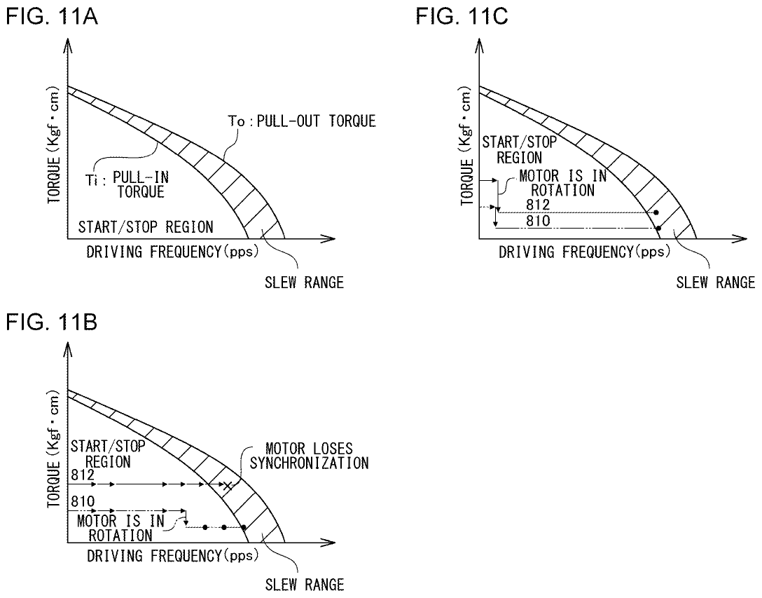

FIGS. 11A-11C show the characteristics of a stepping motor. In particular, FIG. 11A shows an ordinary speed-torque characteristics of a stepping motor. The horizontal axis represents the driving frequency, and the vertical axis represents the torque. The driving frequency represents an input signal for driving the stepping motor, and pps (pulse per second) or Hz (Hertz) is used as a unit. The start/stop region is a frequency range in which it is possible to start the motor, rotate the motor in the normal direction, or rotate the motor in the reverse direction in synchronization with a pulse signal input from outside. A stepping motor that can no longer be operated in synchronization with an input pulse will lose synchronization and will not be operated normally. The start/stop region is a zone in which it is possible to change the motor from a stopped state to a rotated state. Since the motor is in a stopped state, static friction in the motor and the drive load part is dominant. A slew range is a zone in which the motor can respond to an input signal, maintaining synchronization therewith, when the frequency is increased beyond the start/stop region. Dynamic friction of the motor and the drive load part is dominant in the slew range. To start the operation of the motor in a stopped state in consideration of the characteristics discussed above, it is necessary to start the operation by a large torque in the start/stop region so that the frequency at the start of driving is configured to be low. Further, as the frequency is increased after the motor starts its rotation in the start/stop region the range in which the motor can respond (motor response-enabled range) is expanded as far as the slew range of the motor. Therefore, the motor can respond to an input signal, maintaining synchronization therewith, and the driving frequency can be increased without producing loss of synchronization.

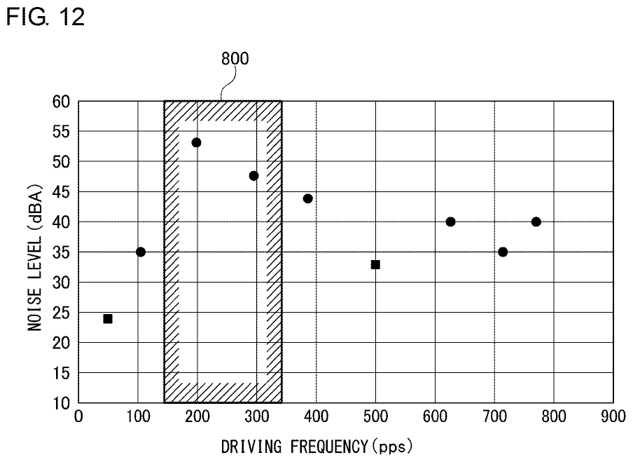

FIG. 12 shows a relationship between the driving frequency and the noise level. The horizontal axis represents the driving frequency, and the vertical axis represents the noise level. The zone in which the driving frequency is about 150 pps to about 350 pps is a resonance frequency range 800. In the resonance frequency range 800, the noise will be large.

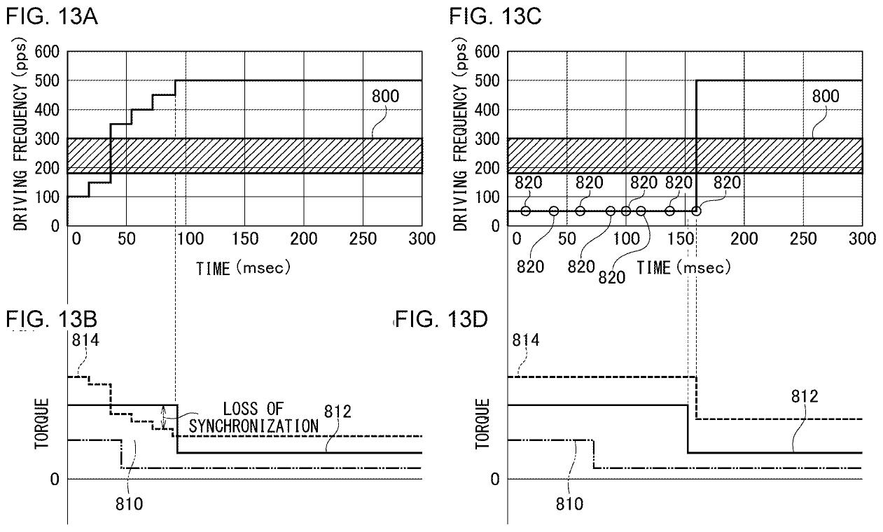

FIGS. 13A-13D show an outline of the operation of the motor. FIGS. 13A-13B show an outline of the operation of a comparative motor, and FIGS. 13C-13D show an outline of the motor according to this embodiment. FIG. 13A shows a relationship between the time elapsed since the comparative motor is started to be driven and the driving frequency. The driving frequency is increased with time in stages until it reaches 500 pps. The figure shows that the motor is driven without using the resonance frequency range 800 in order to suppress the noise of the motor from increasing.

FIG. 13B shows a relationship between the time and the torque in the motor driven as shown in FIG. 13A. An ordinary temperature torque 810 necessary at an ordinary temperature is a torque required to drive the motor at an ordinary temperature (e.g., 25° C.). A description will be given of a torque required to drive the motor, by using the ordinary temperature torque 810. As illustrated, the ordinary temperature torque 810 is high in a phase from a still state to a state in which the motor starts rotating, i.e., in the start/stop region. The ordinary temperature torque 810 is low in the slew range occurring after the motor starts rotating. A low temperature torque 812 necessary at a low temperature is a torque required to drive the motor at a low temperature (e.g., −20° C.). The low temperature torque 812 has similar characteristics as the ordinary temperature torque 810. At a low temperature, however, the grease viscosity will be high so that a torque larger than the ordinary temperature torque 810 is necessary both in the start/stop region and in the slew range.

A motor driving torque 814 is a torque produced when the motor is operated at the driving frequency shown in FIG. 13A. As described above, the driving frequency is increased in stages with time. Therefore, the motor driving torque 814 is decreased in stages with time. So long as the motor driving torque 814 is larger than the necessary torque, the motor does not lose synchronization. At a low temperature, the low temperature torque 812 is larger than the ordinary temperature torque 810 so that the motor driving torque 814 may become smaller than the low temperature torque 812. Therefore, the likelihood of loss of synchronization increases at a low temperature.

FIG. 11B shows a transition of a torque necessary for the motor operation shown in FIG. 13B. As the driving frequency is increased in stages, the edge of the start/stop region is approached. When the ordinary temperature torque 810 is as shown in the graph, the rotation of the motor occurring in the start/stop region has expanded the motor response-enabled range as far as the slew range of the motor. Therefore, the motor can respond to an input signal, maintaining synchronization therewith, and the driving frequency can be increased without producing loss of synchronization. When the low temperature torque 812 is as shown in the graph, on the other hand, an increase in the load resulting from an increase in the viscosity of grease due to the low temperature causes the start/stop region to be exceeded without the rotation of the motor being produced. Consequently, the motor will not be able to respond to an input signal in synchronization therewith so that loss of synchronization is produced.

FIG. 13C shows a relationship between the time elapsed since the motor according to this embodiment is started to be driven and the driving frequency. When the motor is rotated at a constant speed in this embodiment, the stable point 820 occurs periodically. Given that the motor rotation speed is 50 pps, for example, the stable point 820 occurs at an interval of 20 msec. The present disclosure is characterized in that the operation of the motor is switched at the stable point 820. The driving frequency is configured to be low until the first stable point 820 arriving for the first time after the motor response-enabled range is expanded as far as the slew range of the motor owing to the motor rotation in the start/stop region. The driving frequency is increased at the stable point 820. A value measured by an experiment, etc. in advance is used to define a point of time, among the stable point s, when the operation is actually switched (the point of time of the stable point 820 arriving for the first time after the motor response-enabled range is expanded from the start/stop region as far as the slew range).

Referring to FIG. 13C, the driving frequency configured to be low to perform the operation to start the motor is the “first driving frequency”, and the driving frequency configured to be high for high-speed operation is the “second driving frequency”. The first driving frequency is a frequency lower than the resonance frequency range 800 of the motor and is set to, for example, “50 pps”. The second driving frequency is a frequency higher than the resonance frequency range 800 of the motor and is set to, for example, “500 pps”. As shown in FIG. 12, the noise at 50 pps and 500 pps is smaller than the noise in the resonance frequency range 800 so that the noise caused by the motor operation can be suppressed from being increased.

FIG. 13D shows a relationship between the time and the torque in the motor driven as shown in FIG. 13C. The ordinary temperature torque 810 and the low temperature torque 812 are the same as shown in FIG. 13B. The motor driving torque 814 is a torque produced when the motor is operated at the driving frequency shown in FIG. 13C. In other words, the motor is driven at the first driving frequency that produces a sufficiently large motor driving torque 814 to start the operation in the start/stop region. Afterwards, the frequency is changed to the second driving frequency in the slew range in which the necessary torque is smaller. Therefore, the motor driving torque 814 not only larger than the ordinary temperature torque 810 but also larger than the low temperature torque 812 is produced so that loss of synchronization does not occur at a low temperature as well as at an ordinary temperature.

FIG. 11C shows a transition of a torque necessary for the motor operation shown in FIG. 13C. Because the operation is started at the first driving frequency that produces a large driving torque, the rotation of the motor is produced in the start/stop region. Thereafter, the motor response-enabled range is expanded as far as the slew range of the motor so that the motor can respond to an input signal, maintaining synchronization therewith, even if the frequency is switched to the higher second driving frequency. Therefore, the ordinary temperature torque 810 and the low temperature torque 812 are such that synchronized motor rotation that does not produce loss of synchronization can be performed.

The processor 510 of FIG. 9 reads a value in the table at a time interval commensurate with the driving frequency to produce a driving waveform having a pseudo sine wave shape. In that process, the processor 510 starts the operation of the motor at the first driving frequency at a first point of time. At a second point of time later than the first point of time for starting the motor operation, the processor 510 switches to the second driving frequency at which the motor speed is increased. The processor 510 manages the second timing that arrives after the motor response-enabled range is expanded as far as the slew range owing to the motor rotation in the start/stop region.

The second point of time is set to a preset value selected from points of time when the motor is at a stable point. A description of a case in which the second point of time at a low temperature is set to occur 160 msec after start-up. The processor 510 reads a value in the table at a time interval commensurate with the first driving frequency between the first point of time and the second point of time. Further, the processor 510 reads a value in the table at a time interval commensurate with the second driving frequency after the second point of time. The output unit 530 starts operating the motor in a stopped state at the first point of time, using the first driving frequency, and switches from the first driving frequency to the second driving frequency at the second point of time to operate the motor.

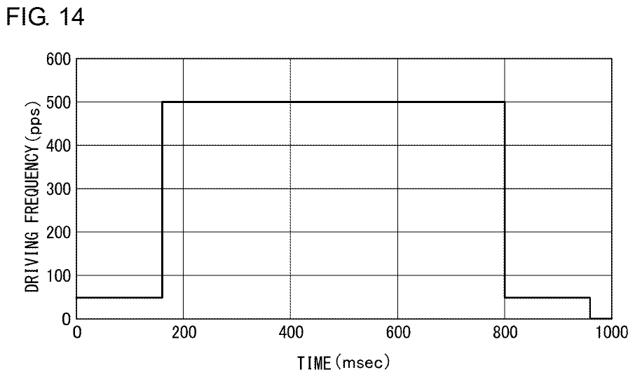

FIG. 14 shows an outline of an alternative operation of the motor. The motor is started to be driven with the use of the first driving frequency. With an elapse of time, the first driving frequency is switched to the second driving frequency, and the motor is driven accordingly. With a further elapse of time, the second driving frequency is switched to the first driving frequency, and the motor is stopped.

The features are implemented in hardware such as a central processing unit (CPU), a memory, or other large scale integration (LSI) of an arbitrary computer and in software such as a program loaded into a memory. The figure depicts functional blocks implemented by the cooperation of these elements. Therefore, it will be understood by those skilled in the art that the functional blocks may be implemented in a variety of manners by hardware only or by a combination of hardware and software.

### (Variation)

In the embodiment described so far, the second point of time is preset as a fixed value. In a variation, the second point of time is adjusted in accordance with the ambient temperature. The charging apparatus 100 according to the variation is further provided with a temperature sensor in addition to the features of FIG. 9, and the temperature sensor is connected to the control apparatus 500. The temperature sensor measures the temperature around the motor, and, for example, the temperature in the vehicle interior 12. A publicly known technology may be used for measurement of the temperature by the temperature sensor, and a description thereof is omitted.

The processor 510 of the control apparatus 500 of FIG. 9 acquires the temperature measured by the temperature sensor. The processor 510 adjusts the second point of time in accordance with the acquired temperature. When the detected temperature is low, for example, the grease viscosity will be high so that the load will be high. It is therefore necessary to extend the time for which the motor is driven at a low speed that produces a large torque. For this reason, the processor 510 extends a period of time from the first point of time to the second point of time such that the lower the acquired temperature, the longer the period set. When the detected temperature is high, on the other hand, the necessary torque will be smaller than at the ordinary temperature. To suppress the heat dissipation of the motor, the processor 510 sets period of time from the first point of time to the second point of time such that the higher the acquired temperature, the shorter the period.

To describe it more specifically, the storage 520 stores a temperature conversion table indicating correspondence between the temperature and the second point of time. To describe it more specifically, the values of the second point of time for switching to the second driving frequency are set for each temperature in the temperature conversion table of the storage 520. As described above, motor stable point s are selected as preset values. In the case of a low temperature, the temperature conversion table sets the second point of time to 160 ms for −20° C. or below, 120 msec for from −20° C. to 25° C., and 80 msec for 25° C. or higher, for example. In the case of a high temperature, similarly, the table sets the second point of time to 80 msec for 25° C. or below, 40 msec for from 25° C. to 50° C., and 0 msec for 50° C. or higher, for example.

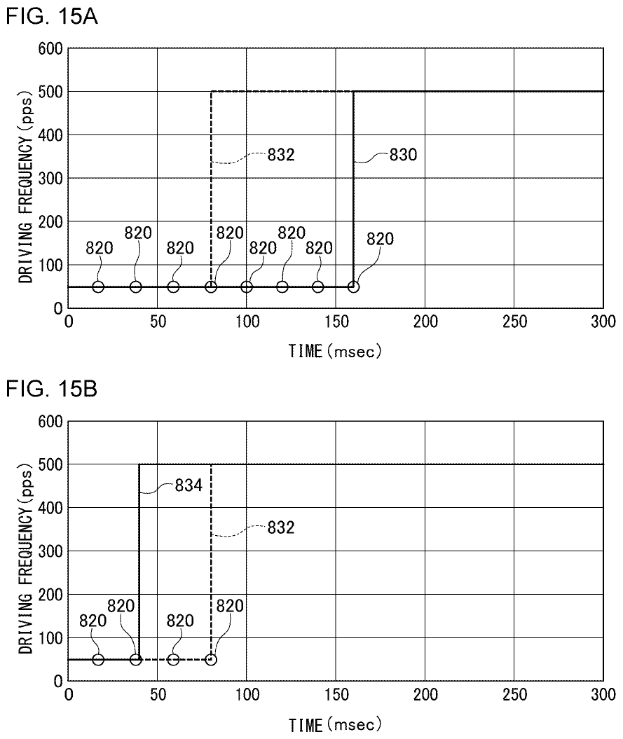

FIGS. 15A-15B show an outline of the operation of the motor. FIG. 15A shows a first example of the variation and shows a case in which the detected temperature is low. When the detected temperature is low, the grease viscosity will be high so that the load will be high. It is therefore necessary to extend the time for which the motor is driven at a low speed that produces a large torque. An ordinary temperature driving frequency 832 indicates the second point of time in the case of 25° C. or higher. As described above, the second point of time is set to 80 msec.

Meanwhile, a low temperature driving frequency 830 indicates the second point of time at a low temperature. The viscosity of grease changes due to the temperature so that the second point of time is changed to a preset value adapted to the change in torque characteristics due to the temperature. FIG. 15A shows a case of −20° C. or lower. As described above, the second point of time is set to 160 ms then, and so the figure shows the same example as shown in FIG. 13C. For example, the low temperature driving frequency 830 is set to 120 msec in the case of from −20° C. to 25° C.

FIG. 15B shows a second example of the variation and shows a case in which the detected temperature is high. When the detected temperature is high, the necessary torque will be smaller than at the ordinary temperature. Meanwhile, the high ambient temperature increases the likelihood that the heat dissipation of the motor adversely affects the reliability of the motor and the driver IC. When the motor is driven at a low speed so that a large torque produced, the amount of heat dissipation will also be large. For this reason, it is desired to suppress the heat dissipation of the motor by configuring the period between the first point of time and the second point of time to be short when the detected temperature is high. An ordinary temperature driving frequency 832 indicates the second point of time in the case of 25° C. or higher. As described above, the second point of time is set to 80 msec.

Meanwhile, a high temperature driving frequency 834 indicates the second point of time at a high temperature. At a high temperature, the second point of time is changed to a preset value adapted to the temperature in order to suppress the heat dissipation of the motor. FIG. 15B shows a case of from 25° C. to 50° C. As described above, the second point of time is set to 40 ms in this case. In the case of 50° C. or higher, for example, the high temperature driving frequency 834 is set to 0 msec. This is equivalent to aligning the first point of time and the second point of time. In that case, the output unit 530 of FIG. 9 operates the motor in a stopped state at the second driving frequency instead of operating it at the first driving frequency.

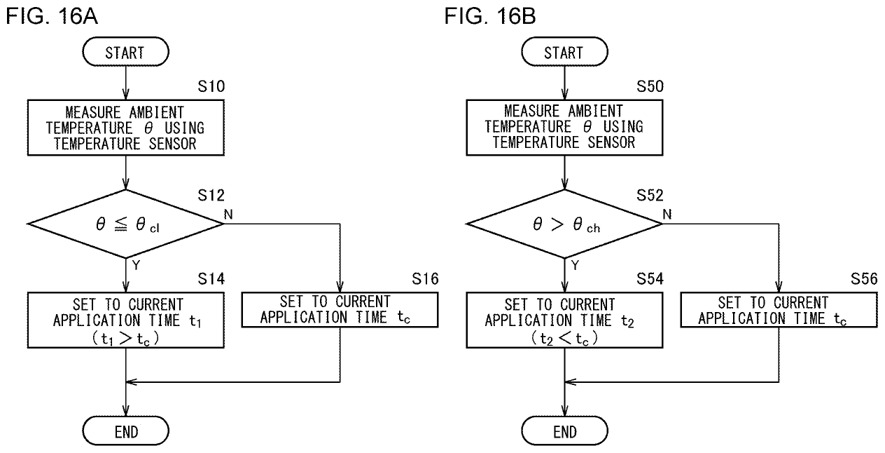

A description will be given of the operation of the charging apparatus 100 having the above-described configuration. FIGS. 16A-16B are flowcharts showing sequences of steps to control the motor. FIG. 16A shows the operation in the first example. The temperature sensor measures an ambient temperature θ (S10). When the ambient temperature θ is equal to or lower than a threshold value θcl (Y in S12), the processor 510 sets the second point of time to a current application time t1 (S14). In this case, t1>tc. When the ambient temperature θ is not equal to or lower than the threshold value θcl (N in S12), the processor 510 sets the second point of time to a current application time tc (S16).

FIG. 16B shows the operation in the second example. The temperature sensor measures the ambient temperature θ (S50). When the ambient temperature θ is higher than a threshold value θch (Y in S52), the processor 510 sets the second point of time to a current application time t2 (S54). In this case, t2>tc. When the ambient temperature θ is not higher than the threshold value θch (N in S52), the processor 510 sets the second point of time to the current application time tc (S56).

According to the embodiment, the motor is operated at the first point of time for starting the motor, using the first driving frequency that produces a sufficiently large torque. At the second point of time, when the motor response-enabled range has been expanded as far as the slew range of the motor owing to the motor rotation in the start/stop region, the first driving frequency is switched to the higher second driving frequency to operate the motor. Accordingly, loss of synchronization of the motor is prevented from occurring in a situation in which the ambient temperature changes. Further, the second point of time is set by using one of points of time when the motor is at a stable point. The first driving frequency is a frequency lower than the resonance frequency range of the motor, and the second driving frequency is a frequency higher than the resonance frequency range of the motor. Accordingly, the noise of the motor can be reduced.

Further, the second point of time is adjusted in accordance with the temperature so that control suitable to the temperature can be performed. At a low temperature, the lower the temperature, the larger the necessary torque. Therefore, loss of synchronization of the motor is prevented from occurring by configuring a time segment during which the torque produced in the motor is large, i.e., the period from the first point of time to the second point of time, to be long. At a high temperature, on the other hand, the higher the temperature, the shorter the period from the first point of time to the second point of time. Therefore, the heat dissipation of the motor can be suppressed. At an even higher temperature, the first point of time and the second point of time are aligned, and the motor in a stopped state is not operated at the first driving frequency but operated at the second driving frequency. Accordingly, the heat dissipation of the motor can be further suppressed.

A summary of an embodiment of the present disclosure is given below. The control apparatus according to an embodiment of the present disclosure includes a controller that operates a motor in a stopped state at a first driving frequency and switches from the first driving frequency to a second driving frequency at a stable point of the motor.

According to this embodiment, the first driving frequency is switched to the second driving frequency at the stable point of the motor so that the torque will not be insufficient and loss of synchronization of the motor is prevented from occurring even in a situation in which the ambient temperature changes.

The first driving frequency is a frequency lower than a resonance frequency range of the motor, and the second driving frequency is a frequency higher than the resonance frequency range of the motor. The first driving frequency and the second driving frequency are outside the resonance frequency range of the motor so that the noise of the motor produced is suppressed.

Another embodiment of the present disclosure also relates to a control apparatus. The apparatus includes a controller that, given a first point of time for starting a motor operation and a second point of time later than the first point of time defined, operates the motor in a stopped state at a first driving frequency since the first point of time and switches from the first driving frequency to a second driving frequency at the second point of time, the second point of time being a stable point of the motor.

According to this embodiment, the second point of time is a stable point of the motor so that the torque will not be insufficient and loss of synchronization of the motor can be prevented from occurring even in a situation in which the ambient temperature changes.

The first driving frequency is a frequency lower than a resonance frequency range of the motor, and the second driving frequency is a frequency higher than the resonance frequency range of the motor. The first driving frequency and the second driving frequency are outside the resonance frequency range of the motor so that the noise of the motor produced is suppressed.

The controller may acquire a temperature measured by a temperature sensor and adjust the second point of time in accordance with the temperature acquired. In this case, the second point of time is adjusted in accordance with the temperature so that control adapted to the temperature can be performed.

The controller may configure a period from the first point of time to the second point of time such that the lower the temperature acquired, the longer the period. In this case, the lower the temperature, the longer the period from the first point of time to the second point of time so that loss of synchronization of the motor is prevented from occurring.

The controller may configure a period from the first point of time to the second point of time such that the higher the temperature acquired, the shorter the period. In this case, the higher the temperature, the shorter the period from the first point of time to the second point of time so that the heat dissipation of the motor can be suppressed.

The controller may align the first point of time and the second point of time, and the motor in a stopped state may not be operated at the first driving frequency but may be operated at the second driving frequency. In this case, the first point of time and the second point of time are aligned, and the motor in a stopped state is not operated at the first driving frequency but is operated at the second driving frequency so that the heat dissipation of the motor can be suppressed.

A charging apparatus may include a motor in which a position of a charging coil is moved and the control apparatus that controls driving of the motor. In this case, a motor in which a position of a charging coil is moved is included so that the charging coil can be moved.

Given above is a description of the present disclosure based on an exemplary embodiment. The embodiment is intended to be illustrative only and it will be understood by those skilled in the art that various modifications to constituting elements and processes could be developed and that such modifications are also within the scope of the present disclosure.

In the embodiment, the charging apparatus 100 is mounted on the vehicle 10. Alternatively, however, the charging apparatus 100 may not be mounted on the vehicle 10 but may be placed on a platform, etc. According to this variation, the range of application can be expanded.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2021-043139, filed on Mar. 17, 2021, and prior Japanese Patent Application No. 2021-180887, filed on Nov. 5, 2021, the entire contents of which are incorporated herein by reference.

What is claimed is:

1. A control apparatus comprising a controller that operates a motor in a stopped state at a first driving frequency and switches from the first driving frequency to a second driving frequency at a stable point of the motor.

2. The control apparatus according to claim 1, wherein
the first driving frequency is a frequency lower than a resonance frequency range of the motor, and
the second driving frequency is a frequency higher than the resonance frequency range of the motor.

3. A control apparatus, comprising:
a controller that, given that a first point of time for starting a motor operation and a second point of time later than the first point of time are defined, operates the motor in a stopped state at a first driving frequency since the first point of time and switches from the first driving frequency to a second driving frequency at the second point of time, the second point of time being a stable point of the motor.

4. The control apparatus according to claim 3, wherein
the first driving frequency is a frequency lower than a resonance frequency range of the motor, and
the second driving frequency is a frequency higher than the resonance frequency range of the motor.

5. The control apparatus according to claim 4, wherein
the controller acquires a temperature measured by a temperature sensor and adjusts the second point of time in accordance with the temperature acquired.

6. The control apparatus according to claim 5, wherein
the controller configures a period from the first point of time to the second point of time such that the lower the temperature acquired, the longer the period.

7. The control apparatus according to claim 5, wherein
the controller configures a period from the first point of time to the second point of time such that the higher the temperature acquired, the shorter the period.

8. The control apparatus according to claim 3, wherein
the controller aligns the first point of time and the second point of time, and
the motor in a stopped state is not operated at the first driving frequency but is operated at the second driving frequency.

9. The control apparatus according to claim 4, wherein
the controller aligns the first point of time and the second point of time, and
the motor in a stopped state is not operated at the first driving frequency but is operated at the second driving frequency.

10. A charging apparatus comprising:
a motor in which a position of a charging coil is moved; and
the control apparatus according to claim 1 that controls driving of the motor.

11. A charging apparatus comprising:
a motor in which a position of a charging coil is moved; and
the control apparatus according to claim 3 that controls driving of the motor.
